(19) United States
(12) Patent Application Publication
(10) Pub. No.: US 2012/0011968 A1
(43) Pub. Date: Jan. 19, 2012

(54) Door Handle Actuator For The Manual Release Of Electronically Controlled Door Lock

(76) Inventor: Gary M. Handerhan, Pittsburgh, PA (US)

(21) Appl. No.: 12/838,440

(22) Filed: Jul. 17, 2010

(51) Int. Cl. E05B 19/20

(52) U.S. Cl. 81/15.9

(57) ABSTRACT

A U-shaped apparatus comprised of a tube with a hook on one end which can be actuated from the other end. The device is used to manipulate the lever mechanism of a locked door from outside of the locked room by sliding said device underneath a door, guiding the device into a position where the hook is above the door lever and pulling on a cable from the other end of the device. The cable being pulled causes the hook to descend grabbing the door lever, pulling it downward and releasing the lock mechanism. The use of the device allows for access to locked rooms when electronic locking devices fail or master keys are unavailable and access to locked rooms becomes necessary.

### CROSS REFERENCE TO RELATED APPLICATION

NONE

### BACKGROUND

### Prior Art

The following is a tabulation of some prior art that presently appears relevant:

### U.S. Patents

| Patent Number | Kind Code | Issue Date | Patentee |
|---|---|---|---|
| 4,876,927 | 81/15.9 | Oct. 31, 1984 | Robert S. Mullen |
| 5,123,307 | 81/15.9 | Jun. 23, 1992 | Robert L. Dyer |
| 7,255,023 | 81/15.9 | Aug. 14, 2007 | Bernard Heath |
| 4,252,218 | 187/61 | Feb. 24, 1981 | David D. Cowardin |
| 5,540,121 | 81/15.9 | July 30, 1996 | Kevin D. Helmers |
| 6,802,542 | 292/1; 81/15.9 | Oct. 12, 2004 | John B. Laufer |

### U.S. Patent Application Publications

| Publication Number | Kind Code | Publ. Date | Applicant |
|---|---|---|---|
| 2007/0256522 | 81/15.9 | Nov. 8, 2007 | Christopher P. Maiorana |

### Foreign Patent Documents

| | | | | |
|---|---|---|---|---|
| Foreign Doc. No. | Country Code | Kind Code | Publ. Date | Appl. or |
| | | | | Patentee |

Many business establishments, especially Hotels and Motels, are now using electronically controlled locking devices on their interior doors. Such devices are powered by electricity, either from a battery contained in the devise or some other source. Once the power source is interrupted, i.e. the battery is fully discharged, the locking device is inoperable and the door remains locked until a power source is restored. In many situations, personnel trained in the replacement or restoration of the power source is unavailable on the premises. This results in customers, guests and management being denied access to the locked room. Such a situation can be extremely inconvenient to customers and guests trying to access the room. It even creates a possible health and safety issue if a person locked inside the room is in need of medical attention and is unable to unlock the door on their own.

Many types of tools have been developed to unlock doors from the outside without the use of a key and without damage to the door or lock. Several of these devices are designed to slip under the door and to reach up to the door knob or handle and to twist and unlock it. However, none of these devices are self contained mechanisms, designed to reach up and pull down a lever-handle typically found in Hotels, Motels and other establishments using the electronic card key systems in widespread use.

Currently existing unlocking devices, such as those depicted in U.S. Pat. Nos. 4,876,927 (1984), 5,123,307 (1992), 5,540,121 (1996), 7,255,023 (2007) and U.S. Patent Application Number 2007/0256522, are comprised of solid rods. The solid rods have various devices attached to them and are designed to slide under a locked door. Once slid under the door, the rods are used to maneuver the devices into position. The devices are then actuated by use of a separately attached cord or wire. The operation of these devices requires the operator to maneuver the rod with one hand while positioning the attached device with his or her other hand. The procedure is cumbersome and requires practice to accomplish. In the preferred embodiment of these devices, the operator is engaging the apparatus onto a door knob rather than the lever handle more commonly found in hotels and motels today.

My invention is comprised of a hollow tube through which a cable runs. This configuration allows the operator to maneuver the apparatus into position with one hand. My invention does not require the maneuvering of a cord or wire, separately attached to the device. The apparatus is self-contained, making the procedure maneuvering into position and actuating the device much simpler. Operating the device requires little or no practice to become proficient in opening the locked door.

The device in U.S. Pat. No. 4,252,218 (1981) is comprised only of a rod, with no attached devices or cords. This device is much easier device to use than the aforementioned patented devices. This rod is configured in such a way that the operator can slide the rod through a narrow opening in the door way; maneuver the rod into position with the lock; and, use the rod manipulate the locking apparatus to disengage the lock. However, this device is specific to locked elevator doors and not applicable to the lever-handled door locks addressed in my invention.

### SUMMARY AND ADVANTAGES

My invention is designed to easily slip underneath a door and be flipped into an upright position and aligns the door with a black line on the device. This black line indicates alignment of the apparatus with the door lever on the inside of the room. Once in position, the operator pulls a handle that pulls a cable attached to the hook. This hook grabs onto the inner lever (handle) of the locked door, pulling it down and unlocking door. The design is specific to lever-handled door openers. Because of this specific design, the process is quick, simple and effective. It requires no expertise in locksmith-ing, maintenance of electronic locks or knowledge of power source restoration. There is no damage done to the door, door lock, door jamb or an part of the premises with the proper usage of this device.

In another embodiment of my invention the device is operated in much the same way. With an extension of the tube, the device can be configured to reach to a length sufficient to engage the ball hook U shaped supplemental latch. The hook apparatus of my invention will be actuated to grasp onto the hook apparatus of the latch system. My device will then be pushed by the operator towards the locked door thus pulling the hook apparatus of the latching system away from the ball portion of the latching system and unlocking the supplemental latch. The procedure is simple and requires little or no practice to become proficient.

### FIRST EMBODIMENT

### Drawings

### Figures

### Drawing 1

### Components of Device

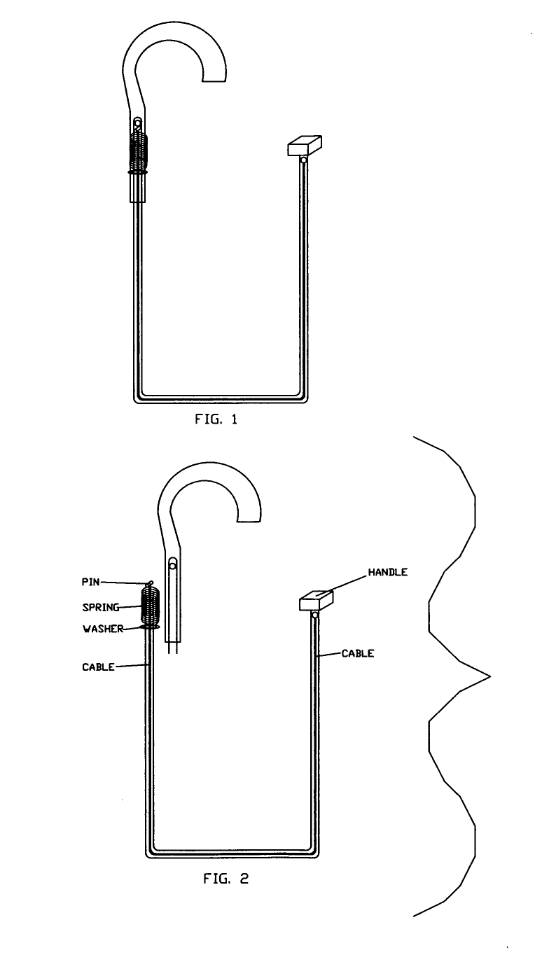

FIG. 1 shows the device completely assembled

FIG. 2 shows an exploded view of device and components

### Drawing 2

### Operation of Device

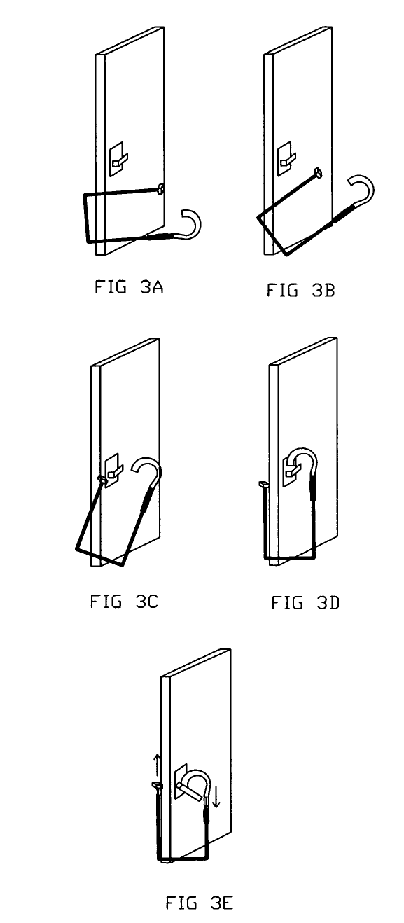

FIG. 3A shows the initial device position

FIG. 3B shows the device being rotated and swung into an upright position

FIG. 3C shows the device in alignment with indicator mark

FIG. 3D shows the device in position to be actuated

FIG. 3E shows the device being actuated

### DRAWING REFERENCE

| Device (Drawing 1) | Operation (Drawing 2) |
|---|---|
| FIG. 1- Device fully assembled | FIG. 3A- Device slipped under doorway |
| FIG. 2 -Exploded view | FIG. 3B - Device being rotated |
| | FIG. 3C- Device being aligned |
| | FIG. 3D - Device in position |
| | FIG. 3E- Device actuated |

### DETAILED DESCRIPTION

### First Embodiment

### Device—Drawing 1

The invention is an apparatus and method for manipulating objects which cannot be manipulated by hand. At present, I believe that the invention operates most efficiently on the lever-handle of a locked door from outside of the room. The invention is constructed of hollow tubing which is bent into a roughly elongated “Open-ended Rhomboid” shape. The tube is hollow and is inserted with a cable which is used to actuate the device. The tube is also marked so that the operator is alerted when the proper position is attained for maneuvering the device above the inside door lever. The cable, which is contained within the tube, is attached to a hook on one end of the device and a “T” handle on the other end of the device. The hook apparatus and tube is narrow enough to be slipped under the doorway.

### Brief Description of Drawings

FIG. 1 shows the fully assembled device. The apparatus is constructed of an “Open-ended Rhomboid” shaped tube through which the cable runs. The tube is of a predetermined circumference to allow it to fit between the opening between a floor and the bottom of a door and it is formed into a shape that will allow it to be swung into operating position after being slid underneath the door. A hook attached to a socket end of the device. The hook end of the device is slid through the space between the bottom of the door and the floor. A handle is attached to the end opposite the hook. The hook is designed to grab onto a door lever when the cable to which it is attached is pulled.

FIG. 2 shows an exploded view of the device. The device consists of the following parts:
1. an “Open-ended Rhomboid” shaped tube
2. a cable which runs through a tube
3. a hook with a socket end
4. a spring
5. a Pin that is inserted through the hook socket and a loop in the end of the cable.

### Operation—Drawing 2

When confronted with a lever-handled door which is locked and cannot be unlocked by conventional means, an operator can use the invention to open the door from outside the room. The operator will position herself on the outside of the locked door. The operator will place the device on the floor and push the hook end of the device under the door. Once the hook end of the device has passed into the locked room, the operator will rotate the device by pulling the end of the device on the outside of the door up. The operator will then maneuver the device into the proper position by aligning the indicator mark of the device with the outside edge of the bottom of the door. Once aligned, the operator will pull the “T” handle of the device in an upward motion. By pulling the handle, the operator caused the cable located within the device to be pulled. This motion acts upon the hook at the other end of the device, pulling it downward. The hook being pulled downward will catch on the lever of the locked door also pulling it downward, The lever's downward action will act to release the door latch and unlock the door.

### Brief Description of Drawings

FIG. 3A shows the device slipped underneath a common door through the space between the floor and the door.

FIG. 3B shows the device being rotated by the pulling of the portion of the device located outside of the door into an upright position.

FIG. 3C shows the device being aligned. This is accomplished by maneuvering the device and lining up the indicator mark on device with the bottom edge of the door.

FIG. 3D shows the hook end of the device in position above the door handle and ready to be actuated

FIG. 3E shows the device being actuated and depicts the downward motion of the hook urged by the cable being pulled at the handle of the device.”

I claim:

1. An apparatus for manipulating the lever mechanism of a locked door, comprising of:
a. A tube of a predetermined circumference to allow it to fit between the opening between a floor and the bottom of a door, formed into an elongated open-ended rhomboid wherein one side of the said open-ended rhomboid is of a length selected to correspond to the vertical distance between the said lever mechanism and said floor and the length of the other side of said open-ended rhomboid of shorter length;
b. a hook attached to a hollow shaft, said shaft of sufficient diameter to allow said shaft to slide over said tube and said shaft of a predetermined circumference to allow it to fit through the opening between a floor and the bottom of a door;
c. a spring seated in said shaft;
d. a handle as a means for pulling a predetermined length of cable contained in said tube;
e. Said cable located inside said tube and attached to said hook on one end of said tube and to said handle on the other end of said tube;
f. A mark made on the said tube at a predetermined position thereby alerting the operator of said apparatus to attaining the proper positioning of the apparatus.

2. The tube of claim 1 wherein said tube material is composed of steel.

3. The handle of claim 1 wherein said handle is t-shaped

4. The cable of claim 1 wherein said cable is permanently attached to the handle.

5. The cable of claim 1 wherein said cable is detachable from the hook.

6. The method of claim 1 wherein the indicator mark is painted onto the tube in a predetermined position.

7. An apparatus for manipulating the hook-ball mechanism of a locked door, comprising of:
a. a tube of a predetermined circumference to allow it to fit between the opening between a floor and the bottom of a door, formed into an elongated open-ended rhomboid wherein one side of the said open-ended rhomboid is of a length selected to correspond to the vertical distance between the said lever mechanism and said floor and the length of the other side of said open-ended rhomboid of shorter length;
b. a hook attached to a hollow shaft, said shaft of sufficient diameter to allow said shaft to slide over said tube and said shaft of a predetermined circumference to allow it to fit through the opening between a floor and the bottom of a door;
c. a spring seated in said shaft;
d. a handle as a means for pulling a predetermined length of cable contained in said tube;
e. said cable located inside said tube and attached to said hook on one end of said tube and to said handle on the other end of said tube;
f. a mark made on the said tube at a predetermined position thereby alerting the operator of said apparatus to attaining the proper positioning of the apparatus.

8. The tube of claim 7 wherein said tube material is composed of steel.

9. The handle of claim 7 wherein said handle is t-shaped

10. The cable of claim 7 wherein said cable is permanently attached to the handle.

11. The cable of claim 7 wherein said cable is detachable from the hook.

12. The method of claim 7 wherein the indicator mark is painted onto the tube in a predetermined position.
